(19) United States
(12) Patent Application Publication
(10) Pub. No.: US 2016/0209694 A1
(43) Pub. Date: Jul. 21, 2016

(54) TRANSFLECTIVE LIQUID CRYSTAL DISPLAY

(71) Applicant: Innolux Corporation, Chu-Nan (TW)

(72) Inventors: Toshiya INADA, Chu-Nan (TW); Minoru SHIBAZAKI, Chu-Nan (TW); Masahiro YOSHIGA, Chu-Nan (TW)

(73) Assignee: INNOLUX CORPORATION, Chu-Nan (TW)

(21) Appl. No.: 14/597,867

(22) Filed: Jan. 15, 2015

(51) Int. Cl. G02F 1/1343; G02F 1/1368

(52) U.S. Cl. CPC G02F 1/13439; G02F 1/1368; G02F 1/134309; G02F 2001/133357

(57) ABSTRACT

A transflective liquid crystal display having a transmissive region and a reflective region and including a first substrate, a second substrate, a liquid crystal layer, a transmissive electrode, a reflective electrode, and a passivation layer is provided. The first substrate includes a thin film transistor element. The liquid crystal layer is disposed between the first substrate and the second substrate. The transmissive electrode and the reflective electrode are disposed on the first substrate, wherein the reflective electrode is arranged corresponding to the reflective region, and the transmissive electrode and the reflective electrode are coupled to the thin film transistor element. A common electrode disposed on the second substrate. The passivation layer is disposed on the first substrate or the second substrate, wherein the passivation layer is arranged corresponding to the reflective electrode and the passivation layer is disposed between the transmissive electrode and the common electrode.

### TECHNICAL FIELD

The disclosure relates in general to a transflective liquid crystal display, and more particularly to a mono-cell gap transflective liquid crystal display.

### BACKGROUND

Liquid crystal displays (LCDs) have been widely used in many electronic device. Currently, LCDs can be divided into three types: transmissive LCDs, reflective LCDs, and transflective LCDs. A transflective LCD uses both a backlight and an external light as the light source; however, light passes through the transmissive region of an LC layer only once and passes through the reflective region twice, resulting in different influence on the different regions of the LC layer.

To deal with this issue, an LC layer may be formed by have different thicknesses in different regions, which is so-called a dual-cell gap transflective LCD. However, the manufacture of such structure is time-consuming, more complicated manufacturing process is required, and other problems, such as brightness issues or LC arrangement disorder, may arise accordingly. Therefore, how to provide a mono-cell gap transflective liquid crystal display having uniform brightness/color has become a prominent task to the industries.

### SUMMARY

The disclosure is directed to a transflective liquid crystal display. In the embodiments, by generating and adjusting a control capacitance within the reflective region of the liquid crystal layer to influence the voltage across the reflective region of the liquid crystal layer, the voltage difference between output voltages across the reflective region and the transmissive region can be controlled, and hence the brightness/color of the reflective region and the transmissive region is uniform.

According to one embodiment of the disclosure, a transflective liquid crystal display is provided. The transflective liquid crystal display includes a first substrate, a second substrate, a liquid crystal layer, a transmissive electrode, a reflective electrode, a common electrode, and a passivation layer. The first substrate includes a thin film transistor element. The liquid crystal layer is disposed between the first substrate and the second substrate. The transmissive electrode and the reflective electrode are disposed on the first substrate, wherein the transmissive electrode and the reflective electrode are coupled to the thin film transistor element. The common electrode is disposed on the second electrode. The passivation layer is disposed on the first substrate or the second substrate, wherein the passivation layer is arranged corresponding to the reflective electrode, and the passivation layer is disposed between the transmissive electrode and the common electrode.

According to another embodiment of the disclosure, a transflective liquid crystal display is provided. The transflective liquid crystal display includes a first substrate, a second substrate, a liquid crystal layer disposed between the first substrate and the second substrate, a transmissive electrode, and a reflective electrode. The first substrate comprises a polysilicon layer disposed on a first base, an insulating layer disposed on the polysilicon layer, a floating metal layer disposed on the insulating layer, a source contact pad, a first drain contact pad, and a second drain contact pad. The source contact pad and the first drain contact pad are electrically connected to the polysilicon layer, and the second drain contact pad is electrically connected to the floating metal layer. The transmissive electrode is electrically connected to the first drain contact pad. The reflective electrode is electrically connected to the second drain contact pad.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a cross-sectional view of a transflective liquid crystal display according to an embodiment of the present disclosure;

FIG. 2 shows Vin vs. Vout curves according to an embodiment of the present disclosure;

FIG. 3A is a cross-sectional view of a transflective liquid crystal display according to another embodiment of the present disclosure;

FIG. 3B is a cross-sectional view of a transflective liquid crystal display according to a further embodiment of the present disclosure;

FIG. 4 is a cross-sectional view of a transflective liquid crystal display according to a yet further embodiment of the present disclosure;

FIG. 5 is a cross-sectional view of a transflective liquid crystal display according to a still further embodiment of the present disclosure;

FIG. 6 is a cross-sectional view of a transflective liquid crystal display according to an additional embodiment of the present disclosure; and

FIG. 7 is a top view of a transflective liquid crystal display according to an embodiment of the present disclosure.

### DETAILED DESCRIPTION

According to the embodiments of the disclosure, in the transflective liquid crystal display, by generating and adjusting a control capacitance within the reflective region of the liquid crystal layer to influence the voltage across the reflective region of the liquid crystal layer, the voltage difference between output voltages across the reflective region and the transmissive region can be controlled, and hence the brightness/color of the reflective region and the transmissive region become more matched and comparable. Detailed descriptions of the embodiments of the disclosure are disclosed below with accompanying drawings. In the accompanying diagrams, the same numeric designations indicate the same or similar components. It should be noted that accompanying drawings are simplified so as to provide clear descriptions of the embodiments of the disclosure, and the following detailed description are exemplary and explanatory only and are not restrictive of the disclosed embodiments as claimed. Anyone who is skilled in the technology field of the disclosure can make necessary modifications or variations to the structures according to the needs in actual implementations.

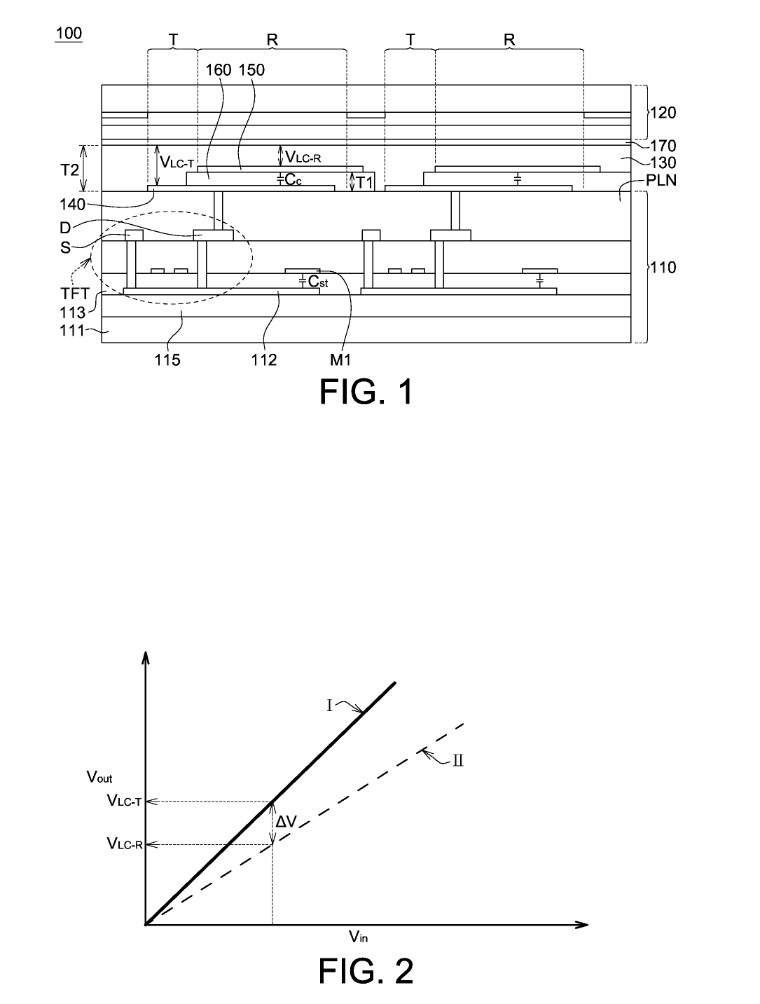

FIG. 1 is a cross-sectional view of a transflective liquid crystal display 100 according to an embodiment of the present disclosure. Referring to FIG. 1, the transflective liquid crystal display 100 has a transmissive region T and a reflective region R. The transmissive region T and the reflective region R are adjacent to each other and surrounded by black matrix (BM). The transflective liquid crystal display 100 includes a first substrate 110, a second substrate 120, a liquid crystal layer 130, a transmissive electrode 140, a reflective electrode 150, and a passivation layer 160. The first substrate 110 includes a plurality of thin film transistor elements TFT. The thin film transistor elements TFT may be disposed adjacent to the transmissive electrode 140 of the transmissive region T, or the thin film transistor elements TFT may be disposed between the first substrate 110 and the reflective electrode 150 to be shielded by the reflective region R for enhancing aperture ratio. The liquid crystal layer 130 is disposed between the first substrate 110 and the second substrate 120. The transmissive electrode 140 and the reflective electrode 150 are disposed on the first substrate 110, wherein the reflective electrode 150 is arranged corresponding to the reflective region R, and the transmissive electrode 140 and the reflective electrode 150 are both electrically coupled to the thin film transistor element TFT. The term “electrically coupled” means that two elements are directly connected to each other, or two elements are interconnected by at least one capacitance. In this embodiment, the transmissive electrode 140 is directly connected to the thin film transistor element TFT, and the reflective electrode 150 is coupled to the transmissive electrode 140 and the thin film transistor element TFT through a capacitance Cc. The passivation layer 160 is disposed between the liquid crystal layer 130 and at least one of the first substrate 110 or the second substrate 120, wherein the passivation layer 160 is arranged corresponding to the reflective electrode 150 and has a first thickness T1 of about 3000-5000 Å. In this embodiment, the passivation layer 160 partially covers the transmissive electrode 140 and the reflective electrode 150 disposed within the passivation layer 160. In other embodiment, the passivation layer 160 fully covers the transmissive electrode 140 of the transmissive region T.

According to the embodiments of the present disclosure, with the arrangement of the passivation layer 160, a coupling capacitance Cc may be generated within the reflective region R of the liquid crystal layer 130, influencing the voltage V_{LC-R} across the reflective region R of the liquid crystal layer 130. Accordingly, without providing two different input voltages respectively to the reflective region R and the transmissive region T or arranging additional transistor elements/bus lines, simply by adjusting the control capacitance, the voltage difference ΔV between output voltage V_{LC-R} across the reflective region R and output voltage V_{LC-T} across the transmissive region T can be controlled and matched, hence the brightness/color of the reflective region R and the transmissive region T become more uniform (similar color gamut). Moreover, according to the embodiments of the present disclosure, the pixel and bus line charging time of the transflective liquid crystal display may be further reduced without arrangements of additional thin film transistors and/or bus lines.

As shown in FIG. 1, in the embodiment, the transflective liquid crystal display 100 includes a common electrode 170 disposed on the second substrate 120. As shown in FIG. 1, the common electrode 170 is located on one side of the liquid crystal layer 130, and the transmissive electrode 140 and the reflective electrode 150 are located on another side of the liquid crystal layer 130 opposite to the common electrode 170. The passivation layer 160 is disposed between the transmissive electrode 140 and the common electrode 170. In the embodiment, the reflective electrode 150 may comprise a light reflecting material, a transparent conductive material, or the combination thereof. The transmissive electrode 140 and the common electrode 170 may respectively comprise a transparent conductive material, such as ITO.

In the present embodiment, the passivation layer 160 is disposed between the transmissive electrode 140 and the reflective electrode 150. As shown in FIG. 1, the transmissive electrode 140 is disposed on the first substrate 110, the passivation layer 160 is disposed on the transmissive electrode 140, and the reflective electrode 150 is disposed on the passivation layer 160. As such, the reflective electrode 150 is floating electrically.

In the embodiment, the arrangement of the passivation layer 160 is corresponding to the reflective electrode 150, substantially defining the reflective region R. Due to the coupling effect between the transmissive electrode 140 and the reflective electrode 150 with the passivation layer 160 interposed therebetween, generating a coupling capacitance Cc between the transmissive electrode 140 and the reflective electrode 150 and corresponding to the reflective region R, the voltage V_{LC-R} across the reflective region R of the liquid crystal layer 130 is smaller than the voltage V_{LC-T} across the transmissive region T of the liquid crystal layer 130. The relationship between the voltage V_{LC-T} and the voltage V_{LC-R} can be represented as follows:

$${V}_{LC - R} = \frac{Cc}{( {C}_{LC - R} + Cc )} * {V}_{LC - T} ,$$

wherein C_{LC-R} indicates the capacitance in the reflective region R of the liquid crystal layer 130, and Vcc is the voltage across the region wherein the coupling capacitance Cc is generated.

In an embodiment, the voltage V_{LC-R} across the reflective region R of the liquid crystal layer 150 is about 0.5-0.8 times of the voltage V_{LC-T} across the transmissive region T of the liquid crystal layer 130. That is, 0.5*V_{LC-T}<V_{LC-R}<0.8*V_{LC-T}.

It is to be noted that although the passivation layer 160 may extend into the transmissive region T, as shown in FIG. 1, the reflective electrode 150 does not extend into the transmissive region T. Accordingly, the coupling capacitance Cc may only be generated within the reflective region R, influencing the voltage V_{LC-R} across the reflective region R of the liquid crystal layer 130. In such case, due to the influence of the coupling capacitance Cc on the reflective region R, the cell retardation of the liquid crystal layer 130 within the reflective region R is different from the cell retardation of the liquid crystal layer 130 within the transmissive region T. For example, while the optimized cell retardation of the liquid crystal layer 130 within the reflective region R is about quarter lambda (¼ λ), the optimized cell retardation of the liquid crystal layer 130 within the transmissive region T is about half lambda (½ λ).

Conventionally, the reflectivity of the reflective electrode causes a brightness/color difference between the reflective region and the transmissive region of the liquid crystal layer in a transflective liquid crystal display when the two electrodes are applied with the same input source voltage V_{S}. In contrast, according to the embodiments of the present disclosure, the voltage V_{LC-R} across the reflective region R is controlled and reduced by the coupling capacitance Cc, while the voltage V_{LC-T} across the transmissive region T is equal to the input source voltage V_{S}, such that by adjusting the coupling capacitance Cc, the voltage difference ΔV between output voltages V_{LC-R} and V_{LC-T} can be controlled, and hence the brightness/color of the reflective region R and the transmissive region T become more matched and uniform.

FIG. 2 shows Vin vs. Vout curves according to an embodiment of the present disclosure. As shown in FIG. 2, curve I represents the relationship between input source voltage V_{S} and the output voltage V_{LC-T} across the transmissive region T, and curve II represents the relationship between input source voltage V_{S} and the output voltage V_{LC-R} across the reflective region R. For the transmissive region T, the output voltage Vout (V_{LC-T}) is substantially equal to the input voltage Vin (V_{S}). For the reflective region R, the output voltage Vout (V_{LC-R}) is smaller than the input voltage Vin (V_{S}). The voltage difference ΔV between the input voltage Vin and the output voltage Vout is controlled by adjusting the coupling capacitance Cc.

Moreover, while the liquid crystal layer 130 has a second thickness T2 of about 3-5 μm, the first thickness T1 of the passivation layer 160 is greatly smaller than the second thickness T2, such that the cell gap of the transflective liquid crystal display 100 across the reflective region R and the transmissive region T is substantially the same, making the transflective liquid crystal display 100 of the present disclosure a mono-cell gap transflective liquid crystal display. Compared to a dual-cell gap transflective liquid crystal display, the mono-cell gap transflective liquid crystal display 100 of the present disclosure has advantages of simplified structures, simplified manufacturing processes, and high aperture ratio, while maintaining uniform brightness/color of the reflective region R and the transmissive region T of the display as aforementioned.

As shown in FIG. 1, in the embodiment, the thin film transistor element TFT of the first substrate 110 includes a first base 111, a polysilicon layer 112, an insulating layer 113, a source contact pad S, and a drain contact pad D. The first substrate 110 may further include a buffer layer 115 disposed on the first base 111, and the buffer layer 115 may be disposed between the first base 111 and the polysilicon layer 112. The polysilicon layer 112 is disposed on the first base 111, the insulating layer 113 is disposed on the polysilicon layer 112, and the source contact pad S and the drain contact pad D are electrically connected to the polysilicon layer 112. As shown in FIG. 1, the drain contact pad D is electrically connected to the transmissive electrode 140, and the reflective electrode 150 is floating electrically. The transflective liquid crystal display 100 further includes a first metal layer M1 disposed on the insulating layer 113, and the insulating layer 113 is located between the first metal layer M1 and the polysilicon layer 112. As such, the first metal layer M1 plays a gate to switch on or off of the thin film transistor element TFT, and a storage capacitance Cst is generated from the coupling between the first metal layer M1 and the polysilicon layer 112. In the embodiment, the first metal layer M1 of the gate is connected to a gate voltage source, and the first metal layer M1 of the storage capacitance Cst is connected to such as a common voltage source.

As shown in FIG. 1, in the embodiment, the first substrate 110 further comprises a planarization layer PLN covering the thin film transistor element TFT. The transmissive electrode 140, the passivation layer 160, and the reflective electrode 150 are disposed on the planarization layer PLN.

As shown in FIG. 1, in the embodiment, the first substrate 110 further comprises a patterned black matrix BM. The patterned black matrix BM together with the transmissive electrode 140 and the reflective electrode 150 defines the transmissive region T and reflective region R. The black matrix BM also covers the thin film transistor element TFT for preventing the channel of the thin film transistor element TFT from light induced current leakage.

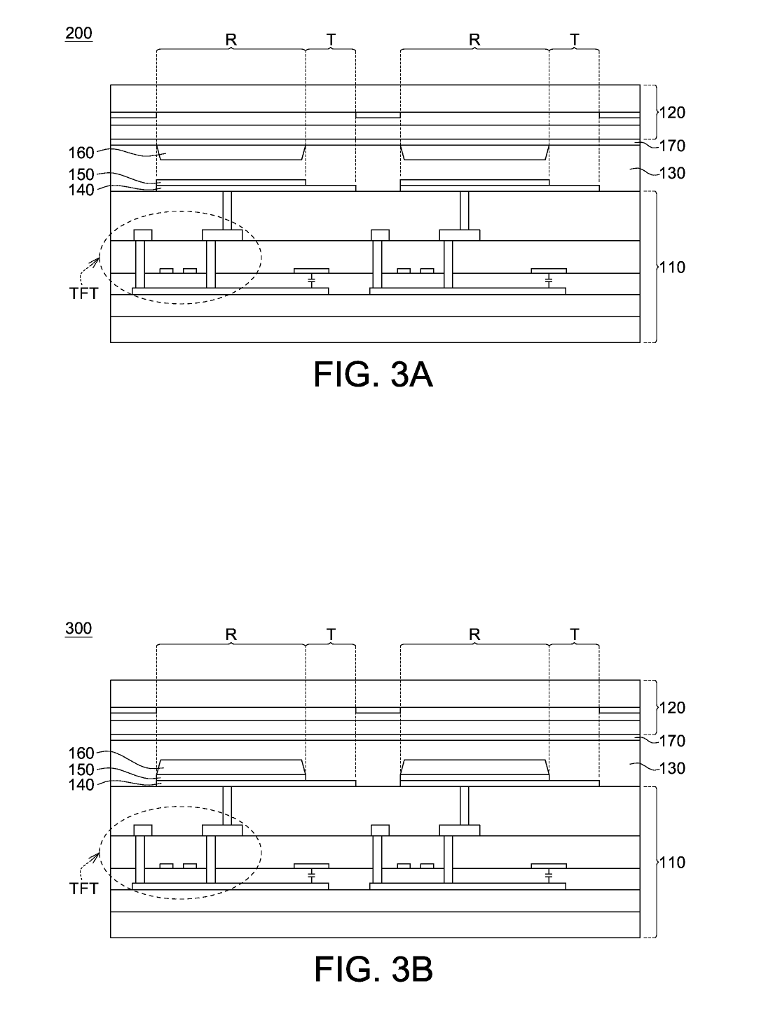

FIG. 3A is a cross-sectional view of a transflective liquid crystal display 200 according to another embodiment of the present disclosure. The elements in the present embodiment sharing the same or similar labels with those in the previous embodiment are the same or similar elements, and the description of which is omitted.

As shown in FIG. 3A and FIG. 3B, in the transflective liquid crystal display 200, the passivation layer 160 is located between the common electrode 170 and the reflective electrode 150. In the embodiment, the reflective electrode 150 is located between the passivation layer 160 and the transmissive electrode 140. According to the embodiments of the present disclosure, the passivation layer 160 is disposed directly on at least one of the common electrode 170 or the reflective electrode 150. As shown in FIG. 3A, in the present embodiment, the passivation layer 160 is disposed between the common electrode 170 and the liquid crystal layer 130. As shown in FIG. 3B, the passivation layer 160 is disposed between the reflective electrode 150 and the liquid crystal layer 130.

As shown in FIG. 3A, in the present embodiment, the reflective electrode 150 is disposed on the transmissive electrode 140, and the reflective electrode 150 is connected with the thin film transistor element TFT through the transmissive electrode 140. In a modified structure of the transflective liquid crystal display 200 of the present embodiment, the reflective electrode 150 may be disposed on the first substrate 110, and the transmissive electrode 140 may be disposed on the reflective electrode 150 (not shown in FIG. 3A), and the transmissive electrode 140 is connected with the thin film transistor element TFT through the reflective electrode 150.

While the passivation layer 160 is arranged corresponding to the reflective electrode 150, the intervening mediums within the reflective region R and the transmissive region T between the common electrode 170 and the transmissive electrode 140/the reflective electrode 150 are different, rendering the voltage V_{LC-R} across the reflective region R of the liquid crystal layer 130 is different from the voltage V_{LC-T} across the transmissive region T of the liquid crystal layer 130. Specifically speaking, while the intervening medium within the reflective region R includes liquid crystal materials and the passivation layer 160, and the intervening medium within the transmissive region T includes only the liquid crystal materials, the voltage V_{LC-R} across the reflective region R of the liquid crystal layer 130 is smaller than the voltage V_{LC-T} across the transmissive region T of the liquid crystal layer 130.

FIG. 3B is a cross-sectional view of a transflective liquid crystal display 300 according to a further embodiment of the present disclosure. The elements in the present embodiment sharing the same or similar labels with those in the previous embodiment are the same or similar elements, and the description of which is omitted.

The transflective liquid crystal display 300 of the present embodiment has a similar structure to the transflective liquid crystal display 200 of the previous embodiment, and the difference is in the arrangement of the passivation layer 160.

As shown in FIG. 3B, the passivation layer 160 is disposed directly on the reflective electrode 150, and the reflective electrode 150 is connected with the thin film transistor element TFT through the transmissive electrode 140. Similar to the modified structure of the transflective liquid crystal display 200 of the previous embodiment, in a modified structure of the transflective liquid crystal display 300 of the present embodiment, the reflective electrode 150 may be disposed on the first substrate 110, and the transmissive electrode 140 may be disposed on the reflective electrode 150 (not shown in FIG. 3B), and the transmissive electrode 140 is connected with the thin film transistor element TFT through the reflective electrode 150.

While the passivation layer 160 is arranged corresponding to the reflective electrode 150, the intervening medium within the reflective region R includes liquid crystal materials and the passivation layer 160, and the intervening medium within the transmissive region T includes only the liquid crystal materials, the voltage V_{LC-R} across the reflective region R of the liquid crystal layer 130 is smaller than the voltage V_{LC-T} across the transmissive region T of the liquid crystal layer 130.

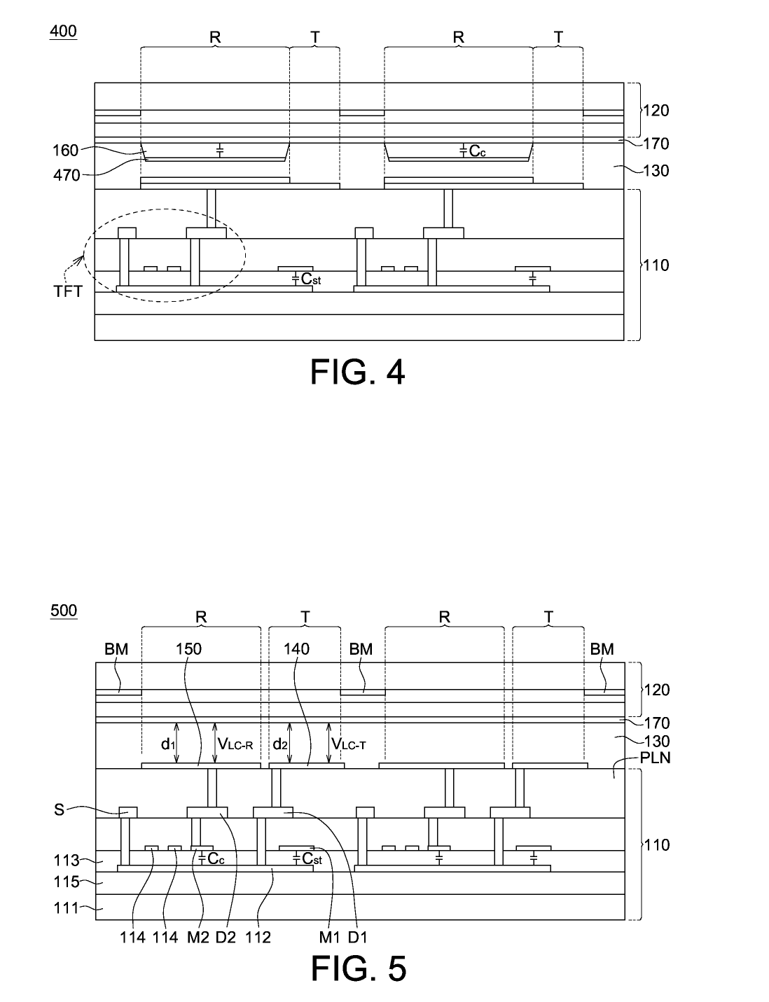

FIG. 4 is a cross-sectional view of a transflective liquid crystal display 400 according to a yet further embodiment of the present disclosure. The elements in the present embodiment sharing the same or similar labels with those in the previous embodiment are the same or similar elements, and the description of which is omitted.

As shown in FIG. 4, the transflective liquid crystal display 400 further includes a floating conductive layer 470 disposed on the passivation layer 160, and the passivation layer 160 is disposed directly on the common electrode 170. As shown in FIG. 4, in the present embodiment, the passivation layer 160 is disposed between the common electrode 170 and the floating conductive layer 470, and the coupling effect between the common electrode 170 and the floating conductive layer 470 with the passivation layer 160 interposed therebetween, generating a coupling capacitance Cc corresponding to the reflective region R; as such, the voltage V_{LC-R} across the reflective region R of the liquid crystal layer 130 is smaller than the voltage V_{LC-T} across the transmissive region T of the liquid crystal layer 130.

FIG. 5 is a cross-sectional view of a transflective liquid crystal display 500 according to a still further embodiment of the present disclosure. The elements in the present embodiments sharing the same or similar labels with those in the previous embodiment are the same or similar elements, and the description of which is omitted.

Referring to FIG. 5, the transflective liquid crystal display 500 has a transmissive region T and a reflective region R. The transflective liquid crystal display 100 includes a first substrate 110, a second substrate 120, a liquid crystal layer 130 disposed between the first substrate 110 and the second substrate 120, a transmissive electrode 140, and a reflective electrode 150. The first substrate 110 comprises a first base 111, a buffer layer 115 disposed on the first base 111, a polysilicon layer 112 disposed on the buffer layer 115 and the first base 111, an insulating layer 113 disposed on the polysilicon layer 112, a floating metal layer M2 disposed on the insulating layer 113, a source contact pad S, a first drain contact pad D1, and a second drain contact pad D2. The buffer layer 115 is disposed between the first base 111 and the polysilicon layer 112. The transflective liquid crystal display 500 further includes a first metal layer M1 disposed on the insulating layer 113. The source contact pad S and the first drain contact pad D1 are electrically connected to the polysilicon layer 112, and the second drain contact pad D2 is electrically connected to the floating metal layer M2. The transmissive electrode 140 is electrically connected to the first drain contact pad D1 and disposed on the first substrate 110. The reflective electrode 150 is electrically connected to the second drain contact pad D2 and disposed on the first substrate 110, wherein the reflective electrode 150 is arranged corresponding to the reflective region R.

As shown in FIG. 5, in the embodiment, the transflective liquid crystal display 500 includes a common electrode 170 disposed on the second substrate 120. As shown in FIG. 5, the common electrode 170 is located on one side of the liquid crystal layer 130, and the transmissive electrode 140 and the reflective electrode 150 are located on another side of the liquid crystal layer 130 opposite to the common electrode 170.

As shown in FIG. 5, in the present embodiment, since the floating metal layer M2 is electrically connected to the reflective electrode 150 through the second drain contact pad D2, due to the coupling effect between the floating metal layer M2 and the polysilicon layer 112 with the insulating layer 113 interposed therebetween, generating a coupling capacitance Cc between the floating metal layer M2 and the polysilicon layer 112 and corresponding to the reflective electrode 150, the voltage V_{LC-R} across the reflective region R of the liquid crystal layer 130 is smaller than the voltage V_{LC-T} across the transmissive region T of the liquid crystal layer 130. As such, by adjusting the coupling capacitance Cc, the voltage difference ΔV between output voltages V_{LC-R} and V_{LC-T} can be controlled, and hence the brightness/color of the reflective region R and the transmissive region T is uniform and matched. A storage capacitance Cst is between the first metal layer M1 and the polysilicon layer 112.

In an embodiment, the voltage V_{LC-R} across the reflective region R of the liquid crystal layer 150 is about 0.5-0.8 times of the voltage V_{LC-T} across the transmissive region T of the liquid crystal layer 130. That is, 0.5*V_{LC-T}<V_{LC-R}<0.8*V_{LC-T}.

As shown in FIG. 5, the reflective electrode 150 is separated from the common electrode 170 by a first distance d1, the transmissive electrode 140 is separated from the common electrode 170 by a second distance d2, and the first distance d1 and the second distance d2 are substantially the same. That is, the transmissive electrode 140 and the reflective electrode 150 are arranged substantially coplanar, making the transflective liquid crystal display 500 of the present disclosure a mono-cell gap transflective liquid crystal display.

As shown in FIG. 5, the first substrate 110 further comprises a gate layer 114 disposed on the insulating layer 113. The gate layer 114, the first metal layer M1, and the floating metal layer M2 are coplanar.

As shown in FIG. 5, the first substrate 110 further comprises a planarization layer PLN covering the source contact pad S, the first drain contact pad D1, and the second drain contact pad D2. In the embodiment, the transmissive electrode 140 and the reflective electrode 150 are disposed on the planarization layer PLN.

As shown in FIG. 5, the second substrate 120 further comprises a patterned black matrix BM. The patterned black matrix BM together with the reflective electrode 150 defines the reflective region R. Moreover, as shown in FIG. 5, the patterned black matrix BM together with the transmissive electrode 140 defines the transmissive region T.

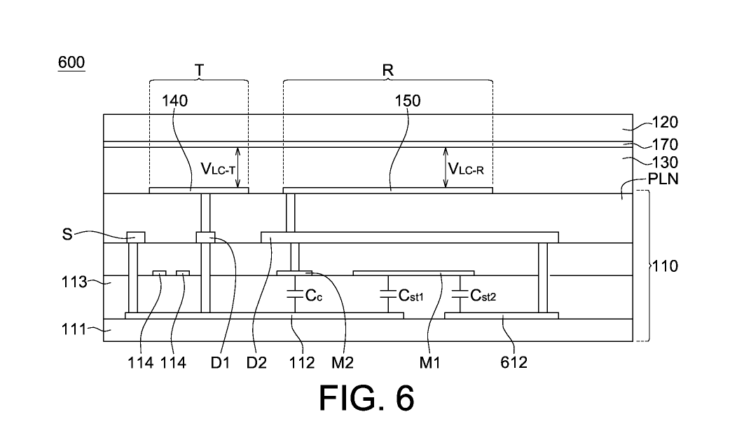

FIG. 6 is a cross-sectional view of a transflective liquid crystal display 600 according to an additional embodiment of the present disclosure The elements in the present embodiments sharing the same or similar labels with those in the previous embodiment are the same or similar elements, and the description of which is omitted.

As shown in FIG. 6, the transflective liquid crystal display 600 includes a first metal layer M1 and a floating polysilicon layer 612. The first metal layer M1 is disposed on the insulating layer 113, and the floating polysilicon layer 612 is disposed on the first base 111. As shown in FIG. 6, in the present embodiment, the insulating layer 113 is disposed between the first metal layer M1 and the floating polysilicon layer 612, and the floating polysilicon layer 612 is connected to the second drain contact pad D2.

Moreover, as shown in FIG. 6, a storage capacitance Cst1 is generated from the coupling between the first metal layer M1 and the polysilicon layer 112. In the embodiment, the first metal layer M1 is connected to such as a common voltage.

In the present embodiment, in addition to the coupling capacitance Cc between the floating metal layer M2 and the polysilicon layer 112 and corresponding to the reflective electrode 150, the coupling effect between the first metal layer M1 and the floating polysilicon layer 612 with the insulating layer 113 interposed therebetween generates a capacitance Cst2 between first metal layer M1 and the floating polysilicon layer 612 and corresponding to the reflective electrode 150 as well. Due to the presence of the coupling capacitance Cc and the capacitance Cst2, the voltage V_{LC-R} across the reflective region R of the liquid crystal layer 130 is smaller than the voltage V_{LC-T} across the transmissive region T of the liquid crystal layer 130. Similar to the rational described in the previous embodiments, by adjusting the control capacitance Cc along with the capacitance Cst2, the voltage difference ΔV between output voltages V_{LC-R} and V_{LC-T} can be controlled, and hence the brightness/color of the reflective region R and the transmissive region T is uniform.

In the present embodiment, the relationship between the voltage V_{LC-R}, the coupling capacitance Cc, and the capacitance Cst2 can be represented as follows:

$${V}_{LC - R} = V cc * \frac{Cc}{{C}_{LC - R} + Cst 2} ,$$

wherein C_{LC-R} indicates the capacitance in the reflective region R of the liquid crystal layer 130, and Vcc is the voltage across the region wherein the coupling capacitance Cc is generated.

Different from the embodiment as shown in FIG. 5, in the present embodiment illustrated in FIG. 6, in addition to adjusting the coupling capacitance Cc, adjusting the capacitance Cst2 provides additional control over the voltage V_{LC-R} across the reflective region R of the liquid crystal layer 130 for further optimizing the uniform brightness/color over the reflective region R and the transmissive region T.

Furthermore, the first metal layer M1 and the floating metal layer M2 may be made from the same metal layer, and the polysilicon layer 112 and floating polysilicon layer 612 may be made from the same polysilicon layer. Hence, the whole manufacturing process is simplified while a higher stability of the voltage V_{LC-R} across the reflective region R of the liquid crystal layer 130 can be achieved for providing a mono-cell gap transflective liquid crystal display 600 with uniform brightness/color.

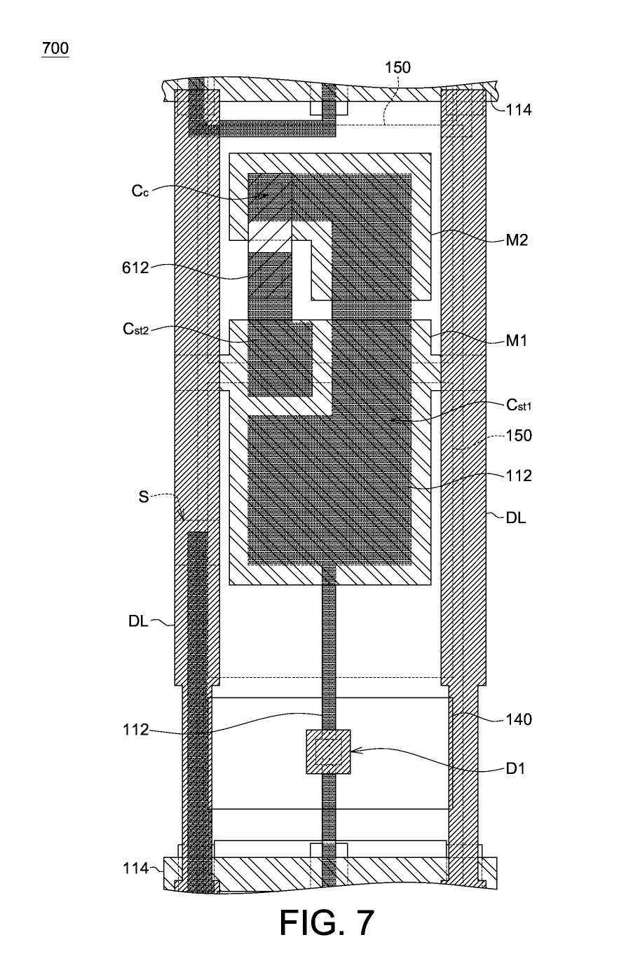

FIG. 7 is a top view of a transflective liquid crystal display 700 according to an embodiment of the present disclosure. The elements in the present embodiments sharing the same or similar labels with those in the previous embodiment are the same or similar elements, and the description of which is omitted.

Referring to FIG. 7, in the embodiment, the transflective liquid crystal display 700 has a transmissive region substantially referring to the transmissive electrode 140 and a reflective region substantially referring to the reflective electrode 150. As shown in FIG. 7, the top view arrangement of the polysilicon layer 112, the floating polysilicon layer 612, the gate layer 114, the first metal layer M1, the floating metal layer M2, the source contact pad S, the first drain contact pad D1, and data lines DL of the transflective liquid crystal display 700 is represented. The source contact pad S and the first drain contact pad D1 are electrically connected to the polysilicon layer 112 for providing signals from the data lines DL.

As shown in FIG. 7, the coupling capacitance Cc is generated from the coupling between the floating metal layer M2 and the polysilicon layer 112 and corresponding to the reflective electrode 150. Moreover, the storage capacitance Cst1 is generated from the coupling between the first metal layer M1 and the polysilicon layer 112 and corresponding to the reflective electrode 150. In addition, the capacitance Cst2 is generated from the coupling between first metal layer M1 and the floating polysilicon layer 612 and corresponding to the reflective electrode 150 as well.

However, it is to be noted that the top view of the transflective liquid crystal display 700 as shown in FIG. 7 is merely showing a type of arrangement of the elements according to the embodiment as shown in FIG. 6 of the present disclosure. Actually, the top view arrangement of the elements as shown in FIG. 7 sharing the same or similar labels with those in the previous embodiment can be modified and varied according to the previous disclosed embodiments, and thus the detailed structure of the transflective liquid crystal display 700 is to be regard as an illustrative sense rather than a restrictive sense.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A transflective liquid crystal display, comprising:
a first substrate and a second substrate, the first substrate comprising a thin film transistor element;
a liquid crystal layer disposed between the first substrate and the second substrate;
a transmissive electrode and a reflective electrode disposed on the first substrate, wherein the transmissive electrode and the reflective electrode are coupled to the thin film transistor element;
a common electrode disposed on the second substrate; and
a passivation layer disposed on the first substrate or the second substrate,
wherein the passivation layer is arranged corresponding to the reflective electrode, and the passivation layer is disposed between the transmissive electrode and the common electrode.

2. The transflective liquid crystal display according to claim 1, wherein the passivation layer is disposed between the transmissive electrode and the reflective electrode.

3. The transflective liquid crystal display according to claim 1, wherein the passivation layer is located between the common electrode and the reflective electrode.

4. The transflective liquid crystal display according to claim 3, wherein the passivation layer is disposed directly on at least one of the common electrode or the reflective electrode.

5. The transflective liquid crystal display according to claim 3, wherein the reflective electrode is located between the passivation layer and the transmissive electrode.

6. The transflective liquid crystal display according to claim 3, wherein the passivation layer is disposed directly on the common electrode, and the transflective liquid crystal display further comprises:
a floating conductive layer disposed on the passivation layer.

7. The transflective liquid crystal display according to claim 1, wherein the passivation layer has a first thickness from 3000 Å to 5000 Å.

8. The transflective liquid crystal display according to claim 1, wherein the thin film transistor element comprises:
a polysilicon layer disposed on a first base;
an insulating layer disposed on the polysilicon layer; and
a source contact pad and a drain contact pad electrically connected to the polysilicon layer;
wherein the transflective liquid crystal display further comprises a first metal layer disposed on the insulating layer, and the insulating layer is located between the first metal layer and the polysilicon layer.

9. The transflective liquid crystal display according to claim 1, wherein the first substrate further comprises a planarization layer covering the thin film transistor element, wherein the transmissive electrode and the reflective electrode are disposed on the planarization layer.

10. The transflective liquid crystal display according to claim 8, wherein the first substrate further comprises a buffer layer disposed between the first base and the polysilicon layer.

11. The transflective liquid crystal display according to claim 1, wherein the reflective electrode comprises a light reflecting material, a transparent conductive material, or the combination thereof.

12. The transflective liquid crystal display according to claim 1, wherein a voltage across the reflective region R of the liquid crystal layer is 0.5-0.8 times of a voltage across a transmissive region T of the liquid crystal layer.

13. A transflective liquid crystal display, comprising:
a first substrate and a second substrate, the first substrate comprising:
a polysilicon layer disposed on a first base;
an insulating layer disposed on the polysilicon layer;
a floating metal layer disposed on the insulating layer;
a source contact pad and a first drain contact pad electrically connected to the polysilicon layer; and
a second drain contact pad electrically connected to the floating metal layer;
a liquid crystal layer disposed between the first substrate and the second substrate;
a transmissive electrode electrically connected to the first drain contact pad; and
a reflective electrode electrically connected to the second drain contact pad.

14. The transflective liquid crystal display according to claim 13, further comprising:
a common electrode disposed on the second substrate.

15. The transflective liquid crystal display according to claim 14, wherein the reflective electrode is separated from the common electrode by a first distance, the transmissive electrode is separated from the common electrode by a second distance, and the first distance and the second distance are substantially the same.

16. The transflective liquid crystal display according to claim 13, further comprising:
a first metal layer disposed on the insulating layer; and
a floating polysilicon layer disposed on the first base, wherein the insulating layer is disposed between the first metal layer and the floating polysilicon layer, and the floating polysilicon layer is connected to the second drain contact pad.

17. The transflective liquid crystal display according to claim 13, wherein the first substrate further comprises a gate layer disposed on the insulating layer.

18. The transflective liquid crystal display according to claim 13, wherein the first substrate further comprises a planarization layer covering the source contact pad, the first drain contact pad, and the second drain contact pad, wherein the transmissive electrode and the reflective electrode are disposed on the planarization layer.

19. The transflective liquid crystal display according to claim 13, wherein the first substrate further comprises a buffer layer disposed between the first base and the polysilicon layer.

20. The transflective liquid crystal display according to claim 13, wherein a voltage across the reflective region R of the liquid crystal layer is 0.5-0.8 times of a voltage across the transmissive region T of the liquid crystal layer.
